(19) United States
(12) Patent Application Publication
(10) Pub. No.: US 2024/0359205 A1
(43) Pub. Date: Oct. 31, 2024

(54) Insert for a Tool for Slot-Die Coating, Tool for Slot-Die Coating, and Method for Producing a Coating

(71) Applicant: Bayerische Motoren Werke Aktiengesellschaft, Muenchen (DE)

(72) Inventor: Dongho JEONG, Neubiberg (DE)

(21) Appl. No.: 18/556,520

(22) PCT Filed: Apr. 8, 2022
(86) PCT No.: PCT/EP2022/059421

§ 371 Date: Oct. 20, 2023

(30) Foreign Application Priority Data
Apr. 21, 2021 (DE) 10 2021 110 121.2

(51) Int. Cl. B05C 5/02; H01M 4/04

(52) U.S. Cl. CPC B05C 5/0254; H01M 4/0411

(57) ABSTRACT

An apparatus for a slot-die coating tool includes an insert that defines a recess which has a distribution region and an outlet channel. The outlet channel is directly adjacent to the distribution region and a mass flow is flowable from the distribution region through the outlet channel in an outlet direction. The distribution region is delimited on at least one side along a boundary line which is transverse to the outlet direction. The outlet channel tapers along a tapering portion in the outlet direction from the boundary line.

### BACKGROUND AND SUMMARY

The invention relates to an insert for a slot-die coating tool, to a slot-die coating tool having such an insert, and to a method for producing a coating.

Slot-die coating is typically utilized to apply thin films of an at least initially flowable material to sheets or other substrates. This is used, for example, in the production of battery cells, in order to apply specific electrochemically active layers. In the process, it is typically sought to ensure that the thickness of the applied layer is as uniform as possible over a width of the substrate material.

It would therefore be desirable to provide measures for increasing the uniformity of the layer thickness.

This is achieved according to the invention by an insert for a slot-die coating tool, by a tool having such an insert, and by a method according to the respective main claims. Advantageous embodiments are claimed for example in the respective dependent claims.

The invention relates to an insert for a slot-die coating tool. A recess, which has a distribution region and an outlet channel directly adjacent thereto, is formed in the insert. A mass flow can exit the distribution region in an outlet direction through the outlet channel. To the sides of the outlet channel, the distribution region is delimited on at least one side along a boundary line which is transverse to the outlet direction. The outlet channel has a tapering form at least along a tapering portion as seen in the outlet direction from the boundary line.

It has been found that such an insert makes it possible to achieve particularly high uniformity of a layer that is to be created. In particular, it can be the case that a greater density or a greater mass flow forms in portions of the distribution region to the sides of the outlet channel than directly adjacent to the outlet channel. This effect can be alleviated by the described tapering of the outlet channel, since the additional material that might flow in from the side is slowed down more uniformly than is the case with an abrupt transition. It has been found that this leads to effective prevention of undesired increases in thickness at the edge of the layer that is to be applied.

A slot-die coating tool is typically constructed such that a first tool component and a second tool component interact, and the insert mentioned is placed between them. The insert serves in particular to allow material that is to be applied to enter the distribution region, in particular through suitable openings in at least one tool component, can be distributed there and then selectively exit via the outlet channel. In this respect, the insert is typically a sheet-like and/or two-dimensional object, with the specified geometric ratios of the insert typically referring only to a two-dimensional view. The recess is therefore open typically in directions transverse to a plane in which the insert extends. The material flow is delimited in these directions by the tool components, which typically directly adjoin the insert during use. A lateral exit of material between the tool components is prevented by the insert, apart from the outlet channel. The insert therefore also has a sealing function.

The insert may be made for example from a flexible and/or elastic material, for example a plastics material or a rubber material. The recess may be created for example by punching or by suitable additive manufacturing of the insert.

In a typical design, the recess is in the form of a two-dimensional recess in the insert, which is also in the form of a two-dimensional, sheet-like object in other respects. The recess thus defines a region in which a material that is to be applied can propagate. In this respect, the distribution region is typically a region which the material enters first. There, it can be distributed and homogenized. Then, it exits via the outlet channel, with the outlet direction specifying a typical direction which can be defined, for example, such that the exiting material has this outlet direction on average. In the process, certain technically caused deviations are common, and therefore it can be the case that the outlet direction cannot be measured exactly at any moment during operation. Rather, it constitutes a property of the insert, which is constructed such that it generates a specific outlet direction.

The designation “to the sides of the outlet channel” is in particular to be considered in a direction along the boundary line. The boundary line is transverse to the outlet direction, this possibly meaning for example an angle of exactly or at least substantially 90°. For example, a maximum deviation between the outlet direction and the boundary line of +1° or +5° may be provided. Edges, which are visible on the insert and define the distribution region at this point, typically extend along the boundary line.

A tapering is to be understood to mean in particular a reduction in the width of the outlet channel. This makes it possible to increase for example the flow velocity of material flowing through. The tapering may in particular be uniform on either side of the outlet channel, for example owing to a suitably shaped periphery of the outlet channel. Such tapering in particular has the effect that material that exits through the outlet channel and comes from portions to the sides of the outlet channel with a greater material flow is homogenized and therefore the otherwise possible formation of higher thicknesses at the peripheries of a layer that is to be applied is avoided.

The distribution region is preferably delimited on either side along the boundary line laterally with respect to the outlet channel. This makes it possible to obtain a uniform structure on either side of the outlet channel.

The distribution region may in particular be rectangular. This has been found to be a straightforward embodiment which conducts the mass flow well.

The insert may in particular be sheet-like and/or have a uniform thickness. This enables easy use between two tool components, which in particular may adjoin the insert over its surface area. The distribution region may in particular be enclosed two-dimensionally on all sides except for the outlet channel. This prevents material from exiting at locations outside the outlet channel, where such an exit is not desired.

The boundary line may in particular be formed at a projection or two projections of the insert that protrude from short sides of the distribution region. Projections of this type may in particular define the outlet channel between them. Accordingly, the insert may in particular have two projections, with the outlet channel being formed between these projections.

The outlet channel may in particular taper continuously along the at least one tapering portion. This can mean in particular that jumps are avoided, as a result of which a more uniform material flow is created.

The outlet channel may in particular be delimited mirror-symmetrically as seen in a plan view of the insert. This enables a uniform delimitation of the outlet channel on either side, with the result that a uniform material flow on either side can be achieved. As an alternative, however, different embodiments are also possible. The mirror symmetry may in particular be with respect to a plane transverse to a plane of extent of the insert or with respect to a line which is in the plane of the insert and is transverse to the boundary line.

According to one embodiment, the at least one tapering portion directly adjoins the boundary line.

According to one embodiment, the at least one tapering portion is spaced apart from the boundary line, it being possible for the outlet channel to have a constant width in particular between the boundary line and the at least one tapering portion.

The outlet channel may wholly or at least partially have a widening form in particular between the at least one tapering portion and an outer end of the outlet channel. This makes it possible to obtain a certain widening and thus deceleration of the material flow, as a result of which in turn the thickness can be homogenized.

The outlet channel may wholly or at least partially have a constant width in particular between the at least one tapering portion and an outer end of the outlet channel. This makes it possible to achieve a uniform material flow.

The outlet channel may be delimited by a projection, which is triangular as seen in a plan view of the insert, laterally on one side or both sides in particular as seen in the outlet direction, with part of the triangular projection forming the tapering portion. This makes it possible to specifically influence the material flow through the triangular projection, which can lead to a suitable flow at the outlet depending on the material. Instead of a triangular projection, it is also possible to use a projection which is more complex and/or polygonal overall.

It is possible in particular to form a respective portion of constant width between the projection and the boundary line and/or between the projection and an outer end of the outlet channel. This makes it possible to homogenize the material flow along such a portion.

The outlet channel may be delimited by a circular-segment-shaped periphery, which is arranged between the at least one tapering portion and an outer end of the outlet channel, laterally on one side or both sides in particular as seen in the outlet direction. Such a circular-segment-shaped periphery may in particular be formed on a respective projection or on another element delimiting the outlet channel. It may selectively influence the flow in the outlet channel and has proven successful, at least in the case of certain materials that are to be applied, to the effect that better homogenization of the thickness of a layer that is to be applied is achieved.

The outlet channel may be delimited by a circular-segment-shaped periphery in particular directly further outward, as seen in the outlet direction, adjacent to the at least one tapering portion. The outlet channel may also be delimited by a portion of constant width in particular directly further outward, as seen in the outlet direction, adjacent to the circular-segment-shaped periphery. The portion of constant width may in particular be at least 1.5 times as long and/or at most 4 times as long as a radius of the circular-segment-shaped periphery. This has proven successful for typical materials that are to be used, since a favorable flow pattern for a uniform thickness is achieved.

The circular-segment-shaped periphery may in particular occupy an angular range of at least 3° and/or at most 15°. This makes it possible to generate suitable flow patterns in the outlet channel which create a particularly uniform thickness for materials that are typically to be used, in particular in the field of producing battery cells.

Between two circular-segment-shaped peripheries or at least on one such periphery, reference can be made in particular to a portion of the outlet channel that is delimited in a circular-segment shape.

The circular-segment-shaped portion may in particular have a radius of at least 3 mm and/or at most 7 mm. Such values have proven successful for typical applications, although it should be mentioned that other values can also be used.

The invention also relates to a slot-die coating tool in which an insert as described in this document for guiding a mass flow has been introduced. With respect to the insert, all of the variants described can be used. The already-mentioned advantages can thus be obtained, with the tool typically having a feed into the distribution region of the insert for material that is to be applied, the material expediently being able to be distributed in this distribution region and then exit through the outlet channel.

The invention also relates to a method for producing a coating using an insert described in this document or a tool described in this document. The advantages already described in this respect can thus be obtained. With respect to the insert or the tool, all of the variants described in this document can be used.

In other words, it should be mentioned that an insert can be optimized, in particular for improved uniformity of the layer thickness, by using one of the following features or combinations of features:
round or circular-segment-shaped form in a center region,
triangular or polygonal form in the center region,
complex or multi-stepped form in the center region.

The invention will now be described on the basis of the figures.

### BRIEF DESCRIPTION OF THE DRAWINGS

FIG. 1 shows an insert according to a first exemplary embodiment;

FIG. 2 shows an insert according to a second exemplary embodiment;

FIG. 3 shows part of an insert according to a third exemplary embodiment; and

FIG. 4 shows a tool.

### DETAILED DESCRIPTION OF THE DRAWINGS

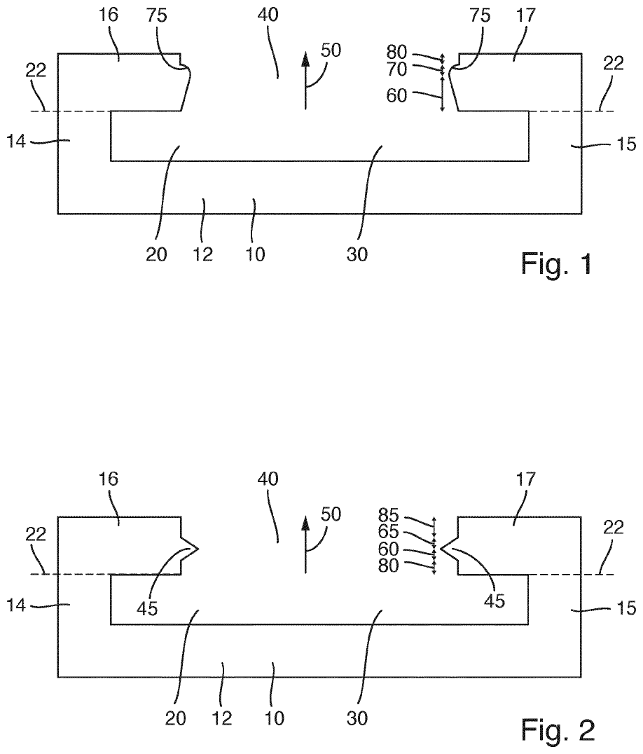

FIG. 1 shows, purely schematically, a plan view of an insert 10 according to a first exemplary embodiment. The insert 10 is in the form of a sheet-like, two-dimensional component of constant thickness. This constant thickness refers to a direction transverse to the plane of the paper of FIG. 1.

A recess 20 is formed in the insert 10. The recess has a distribution region 30, which is rectangular in plan view. This distribution region in turn is delimited on a long side by a first bar 12 and on two short sides by a second bar 14 and a third bar 15. Opposite the first bar 12, the distribution region 30 is delimited by a first projection 16, which protrudes from the second bar 14, and a second projection 17, which protrudes from the third bar 15. An outlet channel 40, which is part of the recess 20 and into which the distribution region 30 directly merges, is formed between the two projections 16, 17.

In principle, the insert 10 can be used such that material that is to be applied is firstly introduced into the distribution region 30. There, it is distributed and then exits through the outlet channel 40, specifically along an outlet direction 50. The outlet direction 50 is defined by the geometric conditions of the insert 10.

At the projections 16, 17, the distribution region 30 is delimited by edges along a boundary line 22. This boundary line is transverse to the outlet direction 50.

In the form shown, a tapering portion 60 of the outlet channel 40, in which the outlet channel 40 tapers, directly adjoins the boundary line 22. This in particular has the effect that a laterally intensified mass flow, which can form in particular to the sides of the outlet channel 40, is suitably conducted and homogenized. The tapering, as shown, is continuous with straight peripheries on either side.

Arranged further to the outside on either side in the present case is a portion 70 with a boundary in the form of a respective circular-segment-shaped periphery 75, that is to say a portion 70 delimited in the shape of a circular arc segment, with the outlet channel 40 widening again in this portion 70. Arranged even further outward is a portion 80 of constant width. It has been found that, in particular in the case of certain materials used in the production of electric battery cells, the described design of the outlet channel 40 makes it possible to achieve particularly high uniformity of a layer thickness that is to be applied.

FIG. 2 shows an insert 10 according to a second exemplary embodiment. In this case, reference will be made below essentially to the differences with respect to the first exemplary embodiment.

In this embodiment, the outlet channel 40 is delimited on either side by a respective projection 45, which is triangular. The tapering portion 60 is formed on this projection, with a widening portion 65, in which the outlet channel 40 widens continuously again, being formed further to the outside. A first portion 80 of constant width is formed between the distribution region 30 and the projection 45. Similarly, a second portion 85 of constant width is formed between the projection 45 and an outer end of the outlet channel 40. Such an embodiment also makes it possible to obtain a particularly uniform coating.

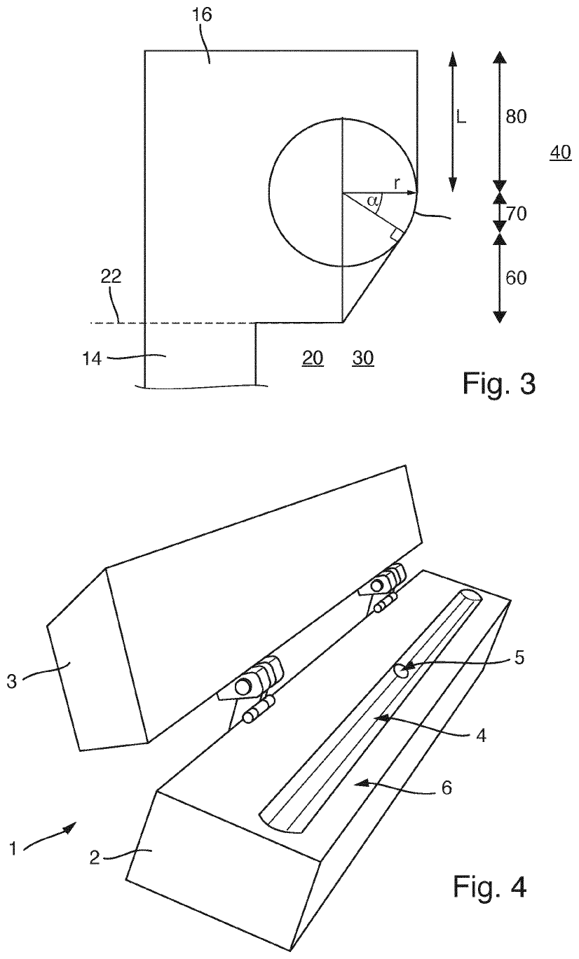

FIG. 3 shows a detail of an insert 10 according to a third exemplary embodiment. In this case, substantially part of the second bar 14 and of the first projection 16 is illustrated. In this embodiment, the tapering portion 60 in which the outlet channel 40 initially continuously tapers directly adjoins the boundary line 22. Directly adjoining the tapering portion is a portion 70, which is delimited in a circular segment shape and in which there is a transition to a portion 80 of constant width. The circular-segment-shaped periphery 75 has a radius r and extends over an angular range a. The portion 80 of constant width has a length L to the outer end. It has been found to be advantageous for numerous materials if the length L is between 1.5 and 4 times as long as the radius r, and if the angle α is between 3° and 15°. In particular, a radius r of 3 mm to 7 mm has been found to be advantageous. However, it should be mentioned that other embodiments can also be used.

FIG. 4 shows a tool 1 according to one exemplary embodiment. This tool 1 has a first tool component 2 and a second tool component 3. These components are pivoted open in the present case but can also be pivoted closed in an operating state, with it being possible for an insert 10 as described above according to one of the exemplary embodiments to be inserted between the two tool components 2, 3.

An elongate groove 4, which is at least approximately aligned with the distribution region 30 in an operating state, is formed in the first tool component 2. An opening 5, through which material for coating can enter the groove 4 and thus also the distribution region 30, is formed in the groove 4. A lip 6, which at least partially is overlapped by the outlet channel 40 of the insert 10, adjoins the groove 4.

Therefore, during operation, it is envisaged that material entering through the opening 5 is distributed in the groove 4 and the distribution region 30 and exits through the outlet channel 40. An exit at another location is prevented by the insert 10. The particular shaping of the outlet channel 40 according to one of the variants or embodiments described in this document has the effect of particularly high uniformity for a coating.

In particular, the embodiments described in this document can be used for water-based anode coating for an electrochemical energy storage cell. In this case, the viscosity can be between 1 000 and 3 000 cPs, for example. However, other values are also possible here.

### LIST OF REFERENCE CHARACTERS

1 Tool
2 First tool component
3 Second tool component
4 Groove
5 Opening
6 Lip
10 Insert
12 First bar
14 Second bar
15 Third bar
16 First projection
17 Second projection
20 Recess
22 Boundary line
30 Distribution region
40 Outlet channel
45 Projection
50 Outlet direction
60 Tapering portion
70 Portion delimited in a circular segment shape
75 Circular-segment-shaped periphery
80 (First) portion of constant thickness
85 Second portion of constant thickness

1.-22. (canceled)

23. An apparatus for a slot-die coating tool, comprising:
an insert, wherein the insert defines a recess which has a distribution region and an outlet channel, wherein the outlet channel is directly adjacent to the distribution region, and wherein a mass flow is flowable from the distribution region through the outlet channel in an outlet direction;
wherein the distribution region is delimited on at least one side along a boundary line which is transverse to the outlet direction;
wherein the outlet channel tapers along a tapering portion in the outlet direction from the boundary line.

24. The apparatus according to claim 23, wherein the distribution region is delimited along the boundary line laterally with respect to the outlet channel.

25. The apparatus according to claim 23, wherein the distribution region is rectangular.

26. The apparatus according to claim 23, wherein the insert has a uniform thickness.

27. The apparatus according to claim 23, wherein the distribution region is enclosed two-dimensionally on all sides except for the outlet channel.

28. The apparatus according to claim 23, wherein the boundary line is formed on a projection of the insert that protrudes from a short side of the distribution region or on two projections of the insert that protrude from short sides of the distribution region.

29. The apparatus according to claim 23, wherein the insert has two projections that protrude from short sides of the distribution region and wherein the outlet channel is formed between the two projections.

30. The apparatus according to claim 23, wherein the outlet channel continuously tapers along the tapering portion.

31. The apparatus according to claim 23, wherein the outlet channel is delimited mirror-symmetrically as seen in a plan view of the insert.

32. The apparatus according to claim 23, wherein the tapering portion directly adjoins the boundary line.

33. The apparatus according to claim 23, wherein the tapering portion is spaced apart from the boundary line and wherein the outlet channel has a constant width between the boundary line and the tapering portion.

34. The apparatus according to claim 23, wherein the outlet channel wholly or at least partially widens between the tapering portion and an outer end of the outlet channel.

35. The apparatus according to claim 23, wherein the outlet channel wholly or at least partially has a constant width between the tapering portion and an outer end of the outlet channel.

36. The apparatus according to claim 23, wherein the outlet channel is delimited by a projection which is triangular as seen in a plan view of the insert, laterally on one side or both sides as seen in the outlet direction, and wherein a part of the triangular projection forms the tapering portion.

37. The apparatus according to claim 36, wherein a portion of constant width is formed between the projection and the boundary line and/or between the projection and an outer end of the outlet channel.

38. The apparatus according to claim 23, wherein the outlet channel is delimited by a circular-segment-shaped periphery which is disposed between the tapering portion and an outer end of the outlet channel laterally on one side or both sides as seen in the outlet direction.

39. The apparatus according to claim 23, wherein the outlet channel is delimited by a circular-segment-shaped periphery directly further outward, as seen in the outlet direction, adjacent to the tapering portion and wherein the outlet channel is delimited by a portion of constant width directly further outward, as seen in the outlet direction, adjacent to the circular-segment-shaped periphery.

40. The apparatus according to claim 39, wherein the portion of constant width is at least 1.5 times as long as and/or at most 4 times as long as a radius of the circular-segment-shaped periphery.

41. The apparatus according to claim 39, wherein the circular-segment-shaped periphery occupies an angular range of at least 3° and/or at most 15°.

42. The apparatus according to claim 39, wherein the circular-segment-shaped periphery has a radius of at least 3 mm and/or at most 7 mm.

43. An apparatus, comprising:
a slot-die coating tool; and
the apparatus according to claim 23 disposed in the slot-die coating tool.

44. (canceled)
